(19) United States
(12) Patent Application Publication
(10) Pub. No.: US 2019/0327160 A1
(43) Pub. Date: Oct. 24, 2019

(54) SYSTEM AND METHOD FOR SCHEDULING AND EXECUTING AUTOMATED TESTS

(71) Applicant: ProKarma, Beaverton, OR (US)

(72) Inventors: Mahalingam Sivaprakasam, Redmond, WA (US); Ramanathan Sathianarayanan, San Ramon, CA (US); Vijay Ijju, Aurora, CA (US)

(21) Appl. No.: 16/387,659

(22) Filed: Apr. 18, 2019

Related U.S. Application Data
(60) Provisional application No. 62/659,165, filed on Apr. 18, 2018.

(51) Int. Cl. H04L 12/26; G06F 11/36

(52) U.S. Cl. CPC H04L 43/0817; H04L 43/065; G06F 11/3688; H04L 43/14; H04L 43/50

(57) ABSTRACT

A system and method for test failure analysis and improvement is disclosed. The system and method includes a plurality of server logs, a plurality of test result logs having an integrated dashboard, an application performance management tool, a platform agnostic test runner, a test execution, an automation test execution and triaging pipeline, a failure analytics engine building a root cause analysis database, and a circuit breaker functioning as a test controller component. The method includes the obtaining a system for performing test data management, executing a plurality of tests for a plurality of test failures, collecting a plurality of application and environment health stats, testing an execution history and a plurality of application health information, analyzing testing results and performing a plurality of failed/stopped tests. The method also includes a corresponding non-transitory computer storage media having instructions stored thereon which, when executed, execute the overall method.

### RELATED APPLICATIONS

The present application claims the benefit of U.S. Provisional Patent Application 62/659,165 filed on Apr. 18, 2018, the entire disclosure of which is incorporated by reference.

### FIELD OF THE INVENTION

The present invention relates generally to a system and method for scheduling and executing. More specifically, the present invention relates generally to a system and method for scheduling and executing automated tests.

### BACKGROUND OF THE INVENTION

Currently there are many challenges in triaging and defect management of automated tests. Although the test execution itself is automated, the triaging and defect management process is manual. This analysis requires Software Development Engineer in Test (SDET's), domain teams, and functional subject matter experts (SME's) to debug and identify failure causes which takes time consuming effort.

Accordingly, there exists a need for automated tests that may be executed at the right time, modified, and re-run to provide a successful outcome. The development of the system and method for scheduling and executing automated tests fulfills this need.

### SUMMARY OF THE INVENTION

It is thus a desired object of the present invention to provide a system for test failure analysis and improvement, comprising a processor system which is responsible for fetching, decoding, executing and writing back a plurality of test failure analysis and improvement data. The system also comprises a plurality of databases and a test failure analysis and improvement non-transitory storage media. The test failure analysis and improvement non-transitory storage media resides on the databases with the test failure analysis and improvement data residing on the test failure analysis and improvement non-transitory storage media. The databases are in electronic communication with the processor system.

The system also provides for a plurality of server logs, a plurality of test result logs having an integrated dashboard; an application performance management tool which links test executions with the server logs and the test result logs each having a test session ID. The test failure analysis and improvement non-transitory storage media generates a special log token for each of the test session IDs. The system also provides a platform agnostic test runner integrating with the application performance management tool to link test executions with the server logs and the test result logs through an application performance management service invoker which abstracts all tool integration details and speeds-up a failure analysis process.

The system also provides a test execution log which contains the application performance management tool information for each test execution. The test execution log speeds-up the failure analysis process. Additionally, the system also provides an automation test execution and triaging pipeline which receives guidance from a continuous integration/continuous delivery orchestrator that automates the test execution and a triage process and a failure analytics engine building a root cause analysis database. The root cause analysis database is a dynamic knowledge database which increases its accuracy of its RCA and resolution.

The system also comprises a circuit breaker which functions as a test controller component. The circuit breaker is a platform agnostic component that ensures a high success rate for executing tests by executing tests. The server logs, the test result logs, the integrated dashboard, the application performance management tool, the test session IDs, the special log tokens, the platform agnostic test runner, the APM service invoker, the platform agnostic component, the test execution log, the automation test execution and triaging pipeline, the continuous integration/continuous delivery orchestrator, the failure analytics engine, and the circuit breaker reside on the performing test data management non-transitory storage media.

The overall system automates the triaging process for test failures thereby ensuring high quality defect resolutions, reduced defects and reduced time for the triaging process. The overall system also includes a platform agnostic product that greatly enables and speeds up the triaging process and enables successful execution of end to end tests in shared unstable quality analysis test environments. The overall system calculates a high success rate probability time for each test and executes and schedules each of the tests for execution during that time enabling a high number of successful test executions in shared QA test environments.

The databases may include a root cause analysis database and an environment downtime tracker database. The integrated dashboard may speed-up the test failure analysis and ensure that one or more proper RCAs are provided for issue resolution. The test execution log may include a pass/fail status, one or more failure error traces and a plurality of linked server and application stats. The root cause analysis database may be based on a plurality of test failures, a plurality of server logs, and a root cause analysis provided by the triage team.

The circuit breaker may calculate the high success rate based on environment health status, application health status, previous similar test runs, and application or environment downtime. The system may further comprise failed/stopped tests that cannot be run due to an environment issue will be auto-scheduled for re-run using a test scheduler. The circuit breaker may also integrate with a testing tool selected from the group consisting of Junit, TestNG, or CA Dev Test using a test execution controller. The test execution controller may result in a platform agnostic manner that is consumed by application performance management tool.

A method for test failure analysis and improvement, comprising the steps of firstly, obtaining a system for performing test data management; secondly, executing a plurality of tests for a plurality of test failures; thirdly, collecting a plurality of application and environment health stats; fourthly, testing an execution history and a plurality of application health information; fifthly analyzing testing results; and lastly performing a plurality of failed/stopped tests. The tests may be performed by a platform agnostic test runner. The collecting step may be performed by the application monitoring tool while the analyzing step may be performed by a circuit breaker. The testing step may be performed with root cause analysis failure.

A non-transitory computer storage media having instructions stored thereon is also provided which, when executed, execute a method comprising the steps of: firstly, obtaining a system for performing test data management; secondly, executing a plurality of tests for a plurality of test failures; thirdly, collecting a plurality of application and environment health stats; fourthly, testing an execution history and a plurality of application health information; fifthly, analyzing testing results; and lastly, performing a plurality of failed/stopped tests. The tests may be performed by a platform agnostic test runner while the collecting step may be performed by the application monitoring tool. The analyzing step may be performed by a circuit breaker while the testing step may be performed with root cause analysis failure.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a flow diagram depicting the logic flow of a system and method for test failure analysis and improvement, according to the preferred embodiment of the present invention.

### DESCRIPTIVE KEY

10. System for test failure analysis and improvement

15. Server logs

20. Application performance management (APM) tool

25. Test result logs

30. Integrated dashboard

35. Test environment

40. Platform agnostic test runner

45. APM service invoker

50. Test execution log

55. Triage team

60. IT support team

65. Automation test execution and triaging pipeline

70. Continuous integration/continuous delivery (CI/CD) orchestrator

75. Failure analytics engine

80. Root cause analysis (RCA) database

85. Circuit breaker

90. Failed/stopped tests

95. Test scheduler

100. Test execution controller

### 1. Description of the Invention

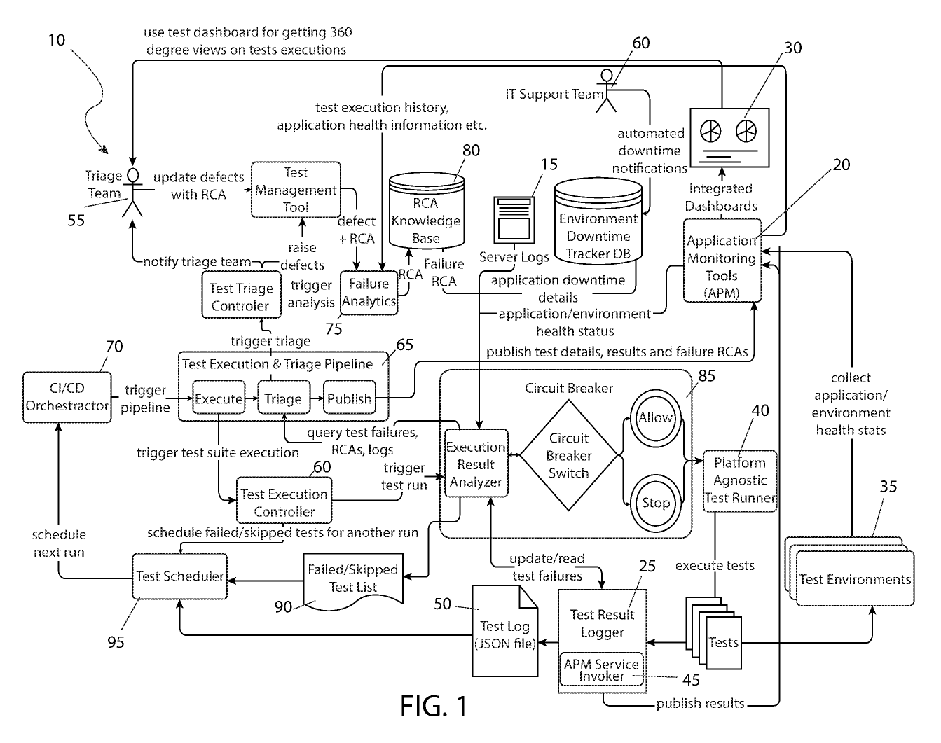

The best mode for carrying out the invention is presented in terms of its preferred embodiment, herein depicted within FIG. 1. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention may be easily incorporated into the teachings of the present invention, and only one (1) particular configuration shall be shown and described for purposes of clarity and disclosure and not by way of limitation of scope. All the implementations described below are exemplary implementations provide to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 2. Detailed Description of the Figure

Referring now to FIG. 1, a flow diagram depicting the logic flow of a system and method for test failure analysis and improvement, according to the preferred embodiment of the present invention is disclosed. The system for test failure analysis and improvement (herein also described as the “system”) 10, is a platform agnostic product that greatly enables and speeds up the test failure triaging process and enables success execution of end to end tests in shared unstable quality analysis (QA) test environments. The system 10 is capable of integrating different data sources such as server logs 15, application performance management (APM) tool 20, and test result logs 25 to build a three-hundred sixty-five-degree (360°) view of test execution through an integrated dashboard 30, thereby speeding-up the test failure analysis. This system 10 can automate the entire triaging process for test failures thereby ensure high quality defect resolutions, reduced defects and reduced time for triaging process. This process can calculate “high success rate” probability time for each test and execute or schedule the test for execution during that time enabling high number of successful test executions in shared QA test environments.

The system 10 operates by linking tests executions with application logs, service logs, and environment logs through integration with APM tools using “test session ID's”. These test sessions ID's are special log tokens that are generated by the system 10 which are then consumed by tests, APM tools, applications and get logged enabling the system 10 to link related logs together.

The system 10 integrates with APM tools 20 which happens in a platform agnostic test runner 40 through an APM service invoker 45 which abstracts all tool integration details. This process then publishes a test execution log 50 containing information including, but not limited to: pass/fail status, failure error traces and linked server and application stats to the application performance management (APM) tool 20 for each test execution. This process greatly speeds up the failure analysis process as a triage team 55 can consider the integrated dashboard 30 and identify the problem areas very fast and route to an IT support team 60 for resolution. This process also greatly speeds up the resolution process as all debug information such as logs, request/response, and test data available in single view for analysis.

An automation test execution and triaging pipeline 65, receiving guidance from a continuous integration/continuous delivery (CI/CD) orchestrator 70 automates the test execution and triaging process. The pipeline component is template based enabling customization of the base template to meet organization's test execution and triaging process. A failure analytics engine 75 will build a root cause analysis (RCA) database 80 based on test failures, server logs, RCA provided by triage team etc. The root cause analysis (RCA) database 80 is not a static database but a dynamic knowledge base which increases its accuracy of its RCA and resolution using learning algorithms and analytics. The data, published to the integrated dashboard 30 raises defects for each test failures, tracks each defect to proper resolution and closing of the defect. Additionally, it routes defects to the IT support team 60 that provide resolution of the defects and ensures that proper RCAs are provided for issue resolution. As such, it greatly reduces the time taken to resolve test failures from days to hours/minutes, it reduces the number of poor-quality defects, and increases quality in overall defect management and resolution process.

A circuit breaker 85, functioning as a test controller component, ensures a high success rate for executing tests by executing tests in a right time window where it will have a high probability of running successfully. This circuit breaker 85 calculates the “high success rate” probability using decision-based algorithms based on factors such as environment health status, application health status, previous similar test runs, and application or environment downtime. Failed/stopped tests 90 that cannot be run due to environment issues will be auto-scheduled for re-run using a test scheduler 95. The circuit breaker 85 is a platform agnostic component that can integrate with different industry testing tool such as Junit, TestNG, CA Dev Test etc. using a test execution controller 100. The test execution controller 100 provides the logic required to invoke tests on different testing tools. It also logs test execution logs and results in platform agnostic manner that can be consumed by application performance management (APM) tool 20. As such the test execution controller 100 provides multiple benefits including but not limited to complete automated test executions with no manual intervention and ensures high probability of test success in shared QA environments by using decision-based algorithms to check if test execution will be successful.

### 3. Operation of the Preferred Embodiment

The preferred embodiment of the present invention may be utilized by the common user in a simple and effortless manner with little or no training. It is envisioned that the system 10 would be constructed in general accordance with FIG. 1.

The system 10 brings efficiency and speed by reducing laborious manual testing tasks typically performed by triage team 55 and IT support team 60 as well as completing overall testing quickly. A circuit breaker 85 applies design patterning to any automated testing strategy or framework for continuous monitoring of current state of the application environment. The circuit breaker 85 stops or breaks the test execution when the environment becomes unstable, and then re-executes the test scripts when the environment is once again stable. The present invention will run in the background as heart beat monitor, validate the current, complete, good and continuous availability of environment, launch appropriate test script that need to be executed, break any potentially failing tests due to such instability and rerun the scripts back when the environment is stable.

A method for test failure analysis and improvement includes the steps of obtaining a system for performing test data management, executing a plurality of tests for a plurality of test failures, collecting a plurality of application and environment health stats, testing an execution history and a plurality of application health information, analyzing testing results and performing a plurality of failed/stopped tests.

The obtaining step includes logging-into the system for performing test data management. The executing step includes the tests are performed by a platform agnostic test runner. The collecting step is performed by the application monitoring tool. The testing step is performed with root cause analysis failure. The analyzing step is performed by a circuit breaker. The performing step is performed by a test scheduler.

The method is performed by a test failure analysis and improvement non-transitory computer storage media having instructions stored thereon which, when executed, execute a method comprising the steps of obtaining a system for performing test data management, executing a plurality of tests for a plurality of test failures, collecting a plurality of application and environment health stats, testing an execution history and a plurality of application health information, analyzing testing results and performing a plurality of failed/stopped tests.

The obtaining step includes logging-into the system for performing test data management. The executing step includes the tests are performed by a platform agnostic test runner. The collecting step is performed by the application monitoring tool. The testing step is performed with root cause analysis failure. The analyzing step is performed by a circuit breaker. The performing step is performed by a test scheduler.

The foregoing descriptions of specific embodiments of the present invention have been presented for purposes of illustration and description. They are not intended to be exhaustive or to limit the invention to the precise forms disclosed, and obviously many modifications and variations are possible considering the above teaching. The embodiments were chosen and described to best explain the principles of the invention and its practical application, to thereby enable others skilled in the art to best utilize the invention and various embodiments with various modifications as are suited to the use contemplated.

What is claimed is:

1. A system for test failure analysis and improvement, comprising:
a processor system responsible for fetching, decoding, executing and writing back a plurality of test failure analysis and improvement data;
a plurality of databases and a test failure analysis and improvement non-transitory storage media, the test failure analysis and improvement non-transitory storage media residing on the databases with the test failure analysis and improvement data residing on the test failure analysis and improvement non-transitory storage media, the databases are in electronic communication with the processor system;
a plurality of server logs;
a plurality of test result logs having an integrated dashboard;
an application performance management tool linking test executions with the server logs and the test result logs each with a test session ID, the test failure analysis and improvement non-transitory storage media generating a special log token for each of the test session IDs;
a platform agnostic test runner integrating with the application performance management tool to link test executions with the server logs and the test result logs through an application performance management service invoker which abstracts all tool integration details and speeds-up a failure analysis process;
a test execution log containing the application performance management tool information for each test execution, the test execution log speeds-up the failure analysis process;
an automation test execution and triaging pipeline receiving guidance from a continuous integration/continuous delivery orchestrator that automates the test execution and a triage process;
a failure analytics engine building a root cause analysis database, the root cause analysis database is a dynamic knowledge database which increases its accuracy of its RCA and resolution;
a circuit breaker functioning as a test controller component, the circuit breaker is a platform agnostic component that ensures a high success rate for executing tests by executing tests; and
the server logs, the test result logs, the integrated dashboard, the application performance management tool, the test session IDs, the special log tokens, the platform agnostic test runner, the APM service invoker, the platform agnostic component, the test execution log, the automation test execution and triaging pipeline, the continuous integration/continuous delivery orchestrator, the failure analytics engine, and the circuit breaker reside on the performing test data management non-transitory storage media;
wherein the overall system automates the triaging process for test failures thereby to ensure high quality defect resolutions, reduced defects and reduced time for the triaging process;
wherein the overall system includes a platform agnostic product that greatly enables and speeds up the triaging process and enables successful execution of end to end tests in shared unstable quality analysis test environments; and
wherein the overall system calculates a high success rate probability time for each test and executes and schedules each of the tests for execution during that time enabling a high number of successful test executions in shared QA test environments.

2. The system for test failure analysis and improvement according to claim 1, wherein the databases include a root cause analysis database and an environment downtime tracker database.

3. The system for test failure analysis and improvement according to claim 1, wherein the integrated dashboard speeds-up the test failure analysis.

4. The system for test failure analysis and improvement according to claim 1, wherein the integrated dashboard ensures that one or more proper RCAs are provided for issue resolution.

5. The system for test failure analysis and improvement according to claim 1, wherein the test execution log includes a pass/fail status, one or more failure error traces and a plurality of linked server and application stats.

6. The system for test failure analysis and improvement according to claim 1, wherein the root cause analysis database is based on a plurality of test failures, a plurality of server logs, and a root cause analysis provided by the triage team.

7. The system for test failure analysis and improvement according to claim 1, wherein the circuit breaker calculates the high success rate based on environment health status, application health status, previous similar test runs, and application or environment downtime.

8. The system for test failure analysis and improvement according to claim 1, further comprising failed/stopped tests that cannot be run due to an environment issue will be auto-scheduled for re-run using a test scheduler.

9. The system for test failure analysis and improvement according to claim 1, wherein the circuit breaker integrates with a testing tool selected from the group consisting of Junit, TestNG, or CA Dev Test using a test execution controller.

10. The system for test failure analysis and improvement according to claim 9, wherein the test execution controller results in a platform agnostic manner that is consumed by application performance management tool.

11. A method for test failure analysis and improvement, comprising the steps of:
obtaining a system for performing test data management;
executing a plurality of tests for a plurality of test failures;
collecting a plurality of application and environment health stats;
testing an execution history and a plurality of application health information;
analyzing testing results; and
performing a plurality of failed/stopped tests.

12. The method for test failure analysis and improvement according to claim 11, wherein the tests are performed by a platform agnostic test runner.

13. The method for test failure analysis and improvement according to claim 11, wherein the collecting step is performed by the application monitoring tool.

14. The method for test failure analysis and improvement according to claim 11, wherein the analyzing step is performed by a circuit breaker.

15. The method for test failure analysis and improvement according to claim 11, wherein the testing step is performed with root cause analysis failure.

16. A non-transitory computer storage media having instructions stored thereon which, when executed, execute a method comprising the steps of:
obtaining a system for performing test data management;
executing a plurality of tests for a plurality of test failures;
collecting a plurality of application and environment health stats;
testing an execution history and a plurality of application health information;
analyzing testing results; and
performing a plurality of failed/stopped tests.

17. The non-transitory computer storage media according to claim 16, wherein the tests are performed by a platform agnostic test runner.

18. The non-transitory computer storage media according to claim 16, wherein the collecting step is performed by the application monitoring tool.

19. The non-transitory computer storage media according to claim 16, wherein the analyzing step is performed by a circuit breaker.

20. The non-transitory computer storage media according to claim 16, wherein the testing step is performed with root cause analysis failure.
